(19) United States
(12) Patent Application Publication
(10) Pub. No.: US 2002/0062916 A1
(43) Pub. Date: May 30, 2002

(54) Method and apparatus for processing semiconductor pellets

(75) Inventor: Tsutomu Mimata, Akiruno (JP)

Correspondence Address: KODA & ANDROLIA, Suite 3850, 2029 Century Park East, Los Angeles, CA, 90067-3024, US

(73) Assignee: KABUSHIKI KAISHA SHINKAWA

(21) Appl. No.: 09/995,343

(22) Filed: Nov. 27, 2001

(30) Foreign Application Priority Data
Nov. 27, 2000 (JP) 2000-359989

(51) Int. Cl. B32B 31/00

(52) U.S. Cl. 156/249; 156/85

(57) ABSTRACT

A method and apparatus for processing semiconductor pellets that are bonded on a wafer substrate that is comprised of a base plate, a heat-shrinkable adhesive agent and a radiation-curable adhesive agent. Prior to supplying the wafer substrate to a pellet pickup section, the adhesive strength of the radiation-curable adhesive agent is weakened by irradiating the wafer substrate with, for instance, ultraviolet light, then a heat treatment is performed by a heater so as to cause heat shrinkage of the heat-shrinkable adhesive agent and to reduce the bonded area between the radiation-curable adhesive agent and the semiconductor pellets. Afterward, the wafer substrate is supplied to the pellet pickup section, and the semiconductor pellets on the wafer substrate are picked up by a suction-chucking nozzle.

### BACKGROUND OF THE INVENTION

1. Field of the Invention

The present invention relates to a semiconductor pellet processing method and apparatus in which a wafer substrate to which semiconductor pellets are bonded is supplied to a pellet pickup section from a wafer cassette so that the semiconductor pellets are picked up from the wafer substrate.

2. Prior Art

Japanese Patent Application Laid-Open (Kokai) Nos. S62-106642, H09-64147 and H04-233249 (Japanese Patent No. 3073239) disclose conventional semiconductor pellet processing apparatuses. In all of these processing apparatuses, when semiconductor pellets are picked up, they are pushed up from below by a push-up needle.

Semiconductor pellets generally have a thickness of 300 to 400 μm. Accordingly, such pellets can be pushed up by a push-up needle. Recently, however, extremely thin semiconductor pellets with a thickness of approximately 40 to 100 μm have started to be used. When such thin semiconductor pellets are pushed up by a push-up needle, the pellets are likely to be damaged by the concentration of stress. Accordingly, there is a demand for a semiconductor pellet processing apparatus that can pick up such thin semiconductor pellets without damage.

### SUMMARY OF THE INVENTION

An object of the present invention to provide a semiconductor pellet processing method and apparatus that picks up thin semiconductor pellets without damaging the pellets.

It is another object of the present invention to provide a semiconductor pellet processing method and apparatus that smoothly picks up the pellets while the semiconductor pellet pickup process is being performed, thus improving the productivity.

The above object is accomplished by unique steps of the present invention for a semiconductor pellet processing method in which semiconductor pellets bonded to a wafer substrate that is fastened to a wafer ring are supplied to a pellet pickup section and picked up one at a time by a suction chucking nozzle; and in the present invention:

the wafer substrate is comprised of at least a base plate, a heat-shrinkable adhesive agent and a radiation-curable adhesive agent, and the unique steps comprise:

weakening the adhesive strength of the radiation-curable adhesive agent by irradiating the wafer substrate with ultraviolet light, etc. prior to the supply of the wafer ring to the pellet pickup section,

performing a heat treatment with a heater so as to cause heat shrinkage of the heat-shrinkable adhesive agent and to reduce the bonded area between the radiation-curable adhesive agent and the semiconductor pellets,

supplying the wafer ring to the pellet pickup section, and

picking up the semiconductor pellets by a suction-chucking nozzle.

The above object is accomplished by further unique steps of the present invention for a semiconductor pellet processing method in which semiconductor pellets bonded to a wafer substrate that is fastened to a wafer ring are supplied to a pellet pickup section and picked up one at a time by a suction chucking nozzle; and in the present invention:

the wafer substrate is comprised of at least a base plate, a heat-shrinkable adhesive agent and a radiation-curable adhesive agent, and the unique steps comprise:

weakening the adhesive strength of the radiation-curable adhesive agent by irradiating the wafer substrate with ultraviolet light, etc. prior to the supply of the wafer ring to the pellet pickup section,

performing a heat treatment with a heater so as to cause heat shrinkage of the heat-shrinkable adhesive agent and to reduce the bonded area between the radiation-curable adhesive agent and the semiconductor pellets,

supplying the wafer ring to the pellet pickup section,

performing a spot heat treatment on the portions of the base plate that correspond to the semiconductor pellets that are to be picked up so as to further weaken the adhesive strength of the radiation-curable adhesive agent, and

picking up the semiconductor pellets by a suction-chucking nozzle.

The above object is also accomplished by a unique structure of the present invention for a semiconductor pellet processing apparatus that comprises:

a wafer cassette that accommodates wafer rings at a fixed pitch, each of the wafer rings being fastened with a wafer substrate to which semiconductor pellets are bonded,

an elevator device that raises and lowers the wafer cassette,

a wafer ring transfer means that transfers the wafer rings accommodated in the wafer cassette and supplies these wafer rings to the pellet pickup section one at a time, and further transfers used wafer rings from which the semiconductor pellets have been picked up back to the wafer cassette, and

a pair of wafer ring guides that guide both side edge portions of the wafer rings transferred by the wafer ring transfer means, and in the present invention,

each of the wafer substrates is comprised of at least a base plate, a heat-shrinkable adhesive agent and a radiation-curable adhesive agent,

a pocket that temporarily accommodates unused wafer rings inside the wafer cassette is disposed in the elevating element of the elevator device, and

a heater that heat-treats the wafer substrates is disposed in the pocket or on a fixed portion of the apparatus that corresponds to the pocket.

In this structure, a spot heat treatment heater can be provided beneath the pickup position of the pellet pickup section. This heater performs a spot heat treatment on the heat-shrinkable adhesive agent and radiation-curable adhesive agent both of which corresponding to a semiconductor pellet that is to be picked up.

### BRIEF DESCRIPTION OF THE DRAWINGS

FIG. 1 is a partially sectional front view of the semiconductor pellet processing apparatus according to one embodiment of the present invention.

FIG. 2 is a top view thereof;

FIGS. 3A through 3F show the wafer ring processing steps according to one embodiment of the present invention;

FIGS. 4A through 4C show the steps that follow the step of FIG. 3F;

FIGS. 5A through 5F show the wafer ring processing steps according to the second embodiment of the semiconductor pellet processing apparatus of the present invention;

FIGS. 6A and 6B show the steps that follow the step of FIG. 5F;

FIGS. 7A and 7B are explanatory diagrams of pellet pickup operation of the present invention;

FIGS. 8A and 8B are explanatory diagrams of another type of pellet pickup operation of the present invention;

FIG. 9A is a front view of a wafer substrate on a wafer ring;

FIG. 9B is an enlarged front view illustrating the layered structure of the wafer substrate;

FIG. 9C is an enlarged front view showing the diced wafer substrate; and

FIG. 9D is an enlarged front view showing the wafer substrate on which the heat treatment is performed in the steps of FIG. 3D and FIG. 5D.

### DETAILED DESCRIPTION OF THE INVENTION

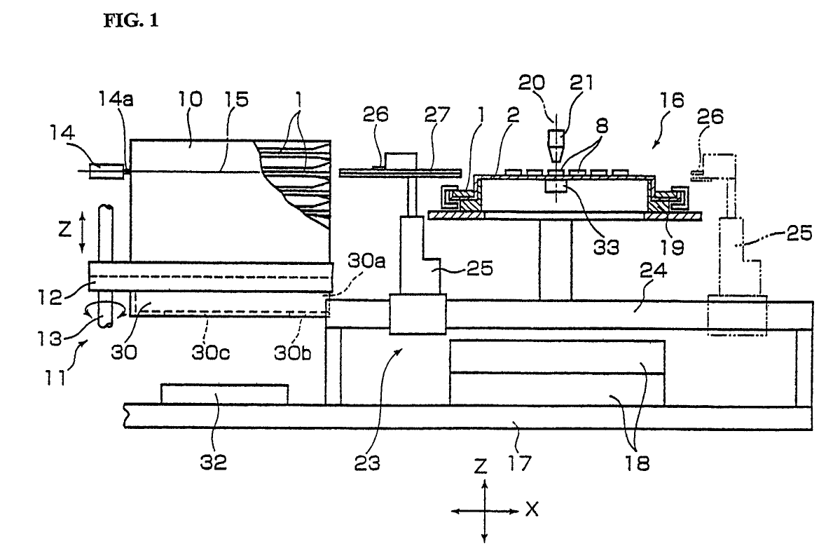

One embodiment of the present invention will be described with reference to FIGS. 1 through 4 and FIG. 9.

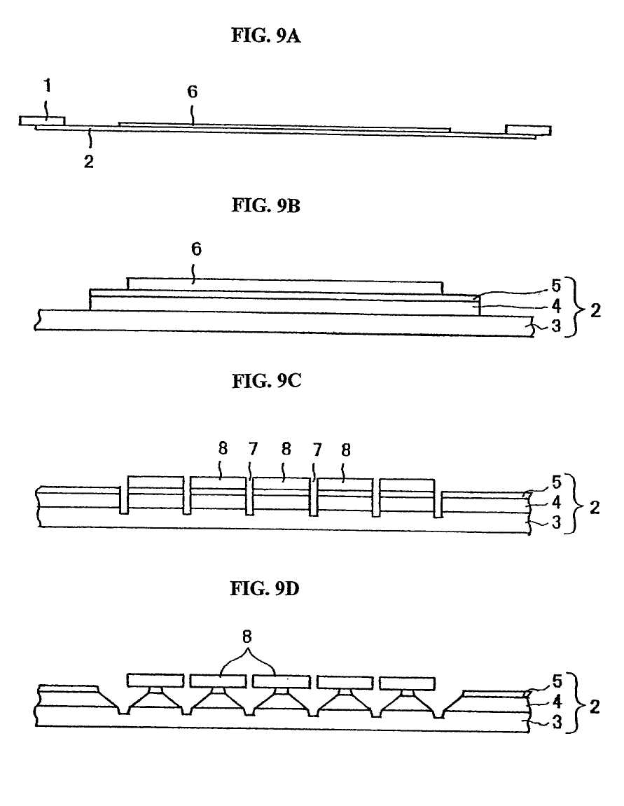

As seen from FIG. 9A, a wafer substrate 2 is attached to a wafer ring 1 at its outer circumferential portion, and a wafer 6 is bonded to this wafer substrate 2. As shown in FIG. 9B, the wafer substrate 2 is comprised of a base plate 3 made of a polyethylene film, a heat-shrinkable adhesive agent 4 disposed on the surface of this base plate 3, and a radiation-curable adhesive agent 5 disposed on the surface of the heat-shrinkable adhesive agent 4. The wafer 6 is fastened to the surface of the radiation-curable adhesive agent 5.

Furthermore, as shown in FIG. 9C, dicing grooves 7 are formed by dicing the wafer 6 that is bonded to the surface of the radiation-curable adhesive agent 5. Individually separated semiconductor pellets 8 are thus formed so that they are lined up in rows along the X- and Y-axes in the horizontal direction.

Japanese Patent No. 3073239, for instance, discloses the thus structured wafer substrate 2.

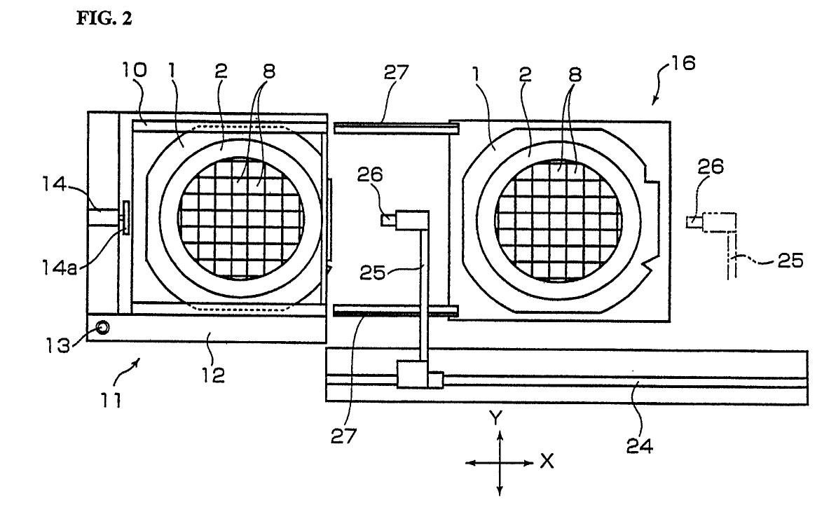

As seen from FIGS. 1 and 2, the semiconductor pellet processing apparatus of the shown embodiment comprises: a wafer cassette 10, an elevator device 11, a pusher 14, a pellet pickup section 16, a wafer ring transfer means 23, and a pair of wafer ring guides 27.

The wafer cassette 10 accommodates wafer rings 1 to which the wafer substrates 2 are fastened. Each of the wafer substrate 2 accommodated in the cassette 10 is in the state shown in FIG. 9C. In other words, the adhesive strength of the radiation-curable adhesive agent 5 has been weakened by, for instance, ultraviolet light irradiated onto the wafer substrates 2. The elevator device 11 raises and lowers the wafer cassette 10, and the pusher 14 pushes out wafer rings 1 from the interior of the wafer cassette 10

The pellet pickup section 16 is disposed on the opposite side from the pusher 14. Also, the pellet pickup section 16 is disposed at a fixed distance from the wafer cassette 10.

The wafer ring transfer means 23 transfers out unused wafer rings 1 one at a time from the interior of the wafer cassette 10 and supplies the wafer rings 1 to the pellet pickup section 16. In addition, the wafer ring transfer means 23 transfers used wafer rings 1 back to their original positions (empty accommodating portion) in the wafer cassette 10. The used wafer rings 1 are those from which the semiconductor pellets 8 have been removed or picked up.

The pair of wafer ring guides 27 guide the wafer rings 1 that are transferred by the wafer ring transfer means 23.

The wafer cassette 10, elevator device 11, pusher 14, wafer ring transfer means 23 and wafer ring guides 27 have known structures as indicated in Japanese Patent Application Laid-Open (Kokai) Nos. S62-106642 and H09-64147. Accordingly, only the essential portions of these devices will be described below. The pellet pickup section 16, unlike the prior art pellet pickup section, does not have a push-up needle that pushes up the semiconductor pellets 8. The remaining structures thereof are the same as in the prior art pellet pickup section.

In the wafer cassette 10, wafer rings 1 are accommodated at a specified pitch in the vertical direction (Z direction). The elevator device 11 has an elevating element 12 which positions the wafer cassette 10, and this elevating element 12 is screw-engaged with a screw shaft 13 that is rotationally driven by a motor (not shown).

The pusher 14 is, for instance, an air cylinder, and is disposed at the wafer ring transferring level 15 so that wafer rings 1 accommodated in the wafer cassette 10 are pushed out by a pusher 14a.

The pellet pickup section 16 includes an XY table 18 that is disposed on a base plate 17. The XY table 18 is driven along the X-and Y-axes in the horizontal direction. A wafer ring holding member 19 that positions and holds wafer rings 1 is disposed on the XY table 18. A suction-chucking nozzle 21 is disposed above the pickup position 20. The suction-chucking nozzle 21 is movable in the Z direction and the X and Y directions by a vertical driving means (not shown) and by the XY table.

The wafer ring transfer means 23 includes a guide rail 24 that extends in the X direction, and a slider 25 which is driven by a driving means (not shown) is fitted over the guide rail 24 so that the slider 25 slides thereon. A chuck 26 which chucks the wafer rings 1 is disposed on the slider 25. The pair of wafer ring guides 27 are disposed at the wafer ring transferring level 15 so as to guide both side edge portions of the wafer rings 1.

The pair of wafer ring guides 27 are disposed fixedly between the wafer cassette 10 and the pellet pickup section 16 as disclosed in Japanese Patent Application Laid-Open (Kokai) No. S62-106642. Alternatively, the wafer ring guides 27 can be disposed so that the guides are rotatable as disclosed in Japanese Patent Application Laid-Open (Kokai) No. H09-64147.

Next, the structure that characterizes the shown embodiment will be described.

A pocket 30 that accommodates wafer rings 1 is disposed on the undersurface of the elevating element 12 of the elevator device 11. This pocket 30 has an opening 30a so that it opens on the wafer ring guides 27 side, and a hole 30c that is smaller than the wafer rings 1 is formed in the bottom plate 30b.

A heater 32 is provided on the base plate 17 so as to positionally correspond to the hole 30c of the pocket 30.

A heater 33 which is movable in the Z direction by a vertical driving means (not shown) is disposed beneath the pickup position 20 of the pellet pickup section 16. The heater 33 has a size that performs a spot heat treatment of only the portion of the heat-shrinkable adhesive agent that corresponds to the semiconductor pellet 8 that is being picked up.

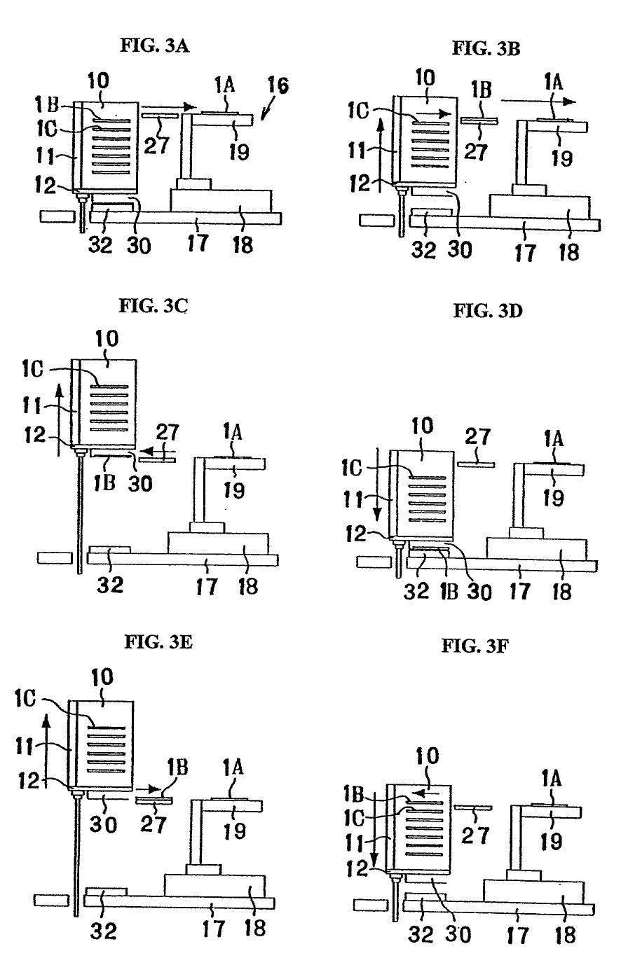

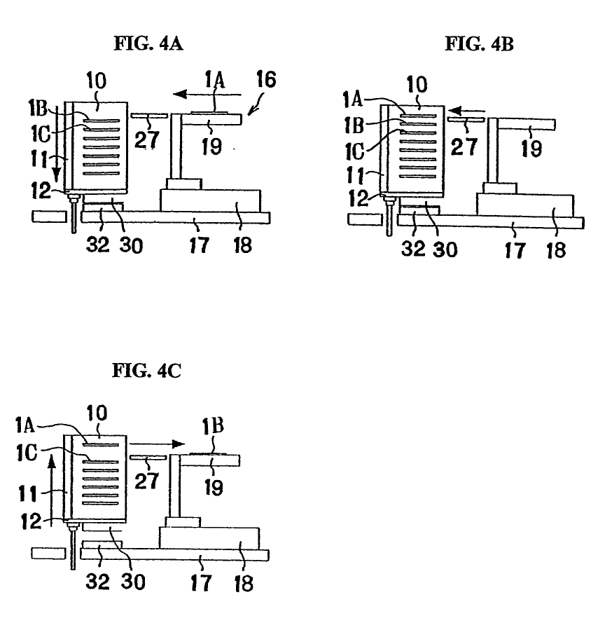

Next, the operation of the above described semiconductor pellet processing apparatus will be described on with reference to FIGS. 3 and 4 as well as FIGS. 1 and 2.

The wafer rings 1A, 1B, 1C . . . accommodated in the wafer cassette 10 are those shown in FIG. 9C. In other words, the wafer substrates in the wafer cassette 10 have been irradiated with ultraviolet light beforehand, and the adhesive strength of the adhesives of approximately 3,000 to 4,000 mN/25 mm is weakened to approximately 100 to 150 mN/25 mm (according to a peeling test using a tape with a width of 25 mm).

In step of FIG. 3A, the uppermost wafer ring 1A accommodated in the wafer cassette 10 is positioned in the wafer ring holding member 19 of the pellet pickup section 16. This wafer substrate 2 in this wafer ring 1A is a heat-treated wafer substrate treated by the heater 32 in steps of FIGS. 3B through 3E as will be described below.

The wafer ring 1A is, in step of FIG. 3A, positioned and held in the wafer ring holding member 19; and before the wafer ring 1A is picked up by the suction chucking nozzle 21 (see FIG. 1), a process as described in detail below will performed on the wafer ring 1A.

More specifically, in step of FIG. 3B, the elevating element 12 is moved up by one pitch, so that the next wafer ring 1B is positioned at the height level of the guide surface of the wafer ring guides 27.

Next, the chuck 26 of the wafer ring transfer means 23 (see FIGS. 1 and 2) is opened and moved toward the wafer cassette 10, and the pusher 14a of the pusher 14 advances and pushes the wafer ring 1B, so that the wafer ring 1B is supplied to the chuck 26.

The chuck 26 next is closed and holds the end portion of the wafer ring 1B. Then, the chuck 26 is moved, together with the slider 25, along the guide rail 24 by a driving means (not shown), so that the wafer ring 1B is placed on the wafer ring guides 27.

Next, in the step of FIG. 3C, the elevating element 12 is raised, so that the pocket 30 is positioned at the level of the guide surface of the wafer ring guide 27. Afterward, the chuck 26 of the wafer ring transfer means 23 is moved toward the wafer cassette 10, and the wafer ring 1B is put in the pocket 30. Then, the chuck 26 opens and is retracted. The chuck 26 thus returns to its original position that is shown by the solid line in FIG. 1.

In the next step of FIG. 3D, the elevating element 12 is lowered, and the pocket 30 comes into contact with the heater 32. As a result, the wafer substrate in the wafer ring 1B is heated. This heating is performed for a specified period of time. As a result of this heating, as shown in FIG. 9D, the heat-shrinkable adhesive agent 4 shrinks, and the radiation-curable adhesive agent 5 also shrinks. The adhesive strength of the radiation-curable adhesive agent 5 is thus further weakened (since ultraviolet light irradiation has been executed previously as described above).

After a specified time, the elevating element 12 is raised, and the pocket 30 is separated from the heater 32.

In this way, the heat-shrinkable adhesive agent 4 and radiation-curable adhesive agent 5 both of which correspond to each semiconductor pellet 8 are heat-treated.

The heater 32 heats the wafer substrate in the wafer ring 1B only while the pocket 30 is in contact with the heater 32, there are no particular restrictions on the on-off timing of the heater 32.

Next, in the step of FIG. 3E, the pocket 30 is raised so that the pocket 30 is positioned at the level of the guide surface of the wafer ring guides 27, and the chuck 26 is advanced and then closes so as to chuck the wafer ring 1B. The chuck 26 then retracts so that the wafer ring 1B is pulled out of the pocket 30, and the wafer ring 1B is placed on the wafer ring guides 27.

In the step of FIG. 3F, the wafer cassette 10 is lowered so that the accommodating portion of the wafer cassette 10 in which the wafer ring 1B was accommodated is positioned at the level of the guide surface of the wafer ring guides 27. Then, the chuck 26 advances so that the wafer ring 1B is accommodated in the wafer cassette 10, after which the chuck 26 opens and retracts.

Afterward, in the step of FIG. 4A, the elevating element 12 is lowered by one pitch. As a result, the accommodating portion for the wafer ring 1A in the wafer cassette 10 is positioned at the level of the guide surface of the wafer ring guides 27, so that the wafer cassette 10 is ready to receive the wafer ring 1A.

When all of the semiconductor pellets 8 on the wafer substrate in the wafer ring 1A that is at the pellet pickup section 16 have been picked up by the suction chucking nozzle 21 in a process that will be described later, the steps of FIGS. 4B and 4C are subsequently performed. This is done by operations similar to those described in the above-described Japanese Patent Application Laid-Open (Kokai) Nos. S62-106642 and H09-64147.

More specifically, the wafer ring 1A is chucked by the chuck 26 and is accommodated in its original accommodating portion in the wafer cassette 10 in the step of FIG. 4B. In the next step of FIG. 4C, the elevating element 12 is raised by one pitch so that the wafer ring 1B is positioned at the level of the guide surface of the wafer ring guides 27, the wafer ring 1B is chucked by the chuck 26 and transferred to the wafer ring holding member 19 of the pellet pickup section 16, and the wafer ring 1B is positioned and held in the wafer ring holding member 19.

Subsequently, the above-described series of operations is performed for all of the wafer rings 1 inside the wafer cassette 10.

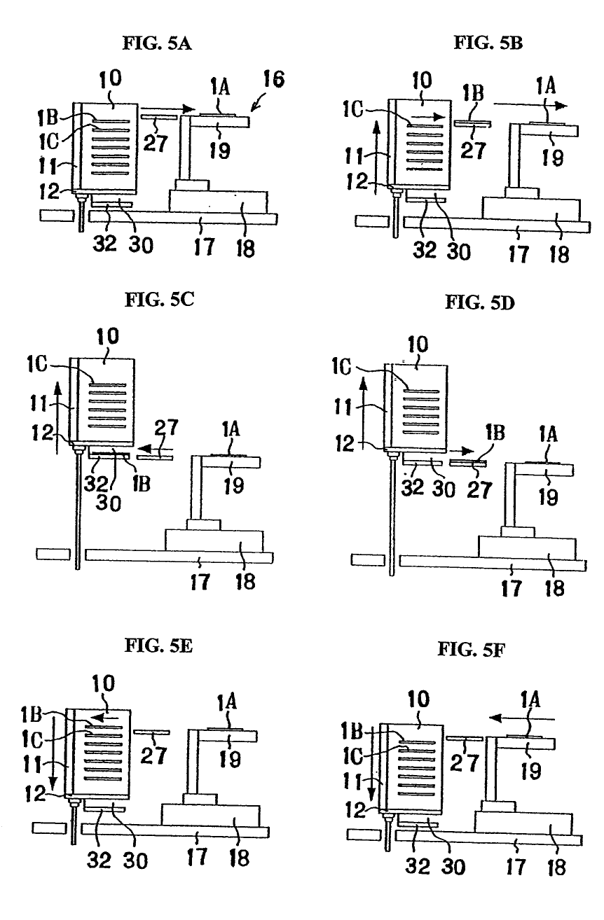

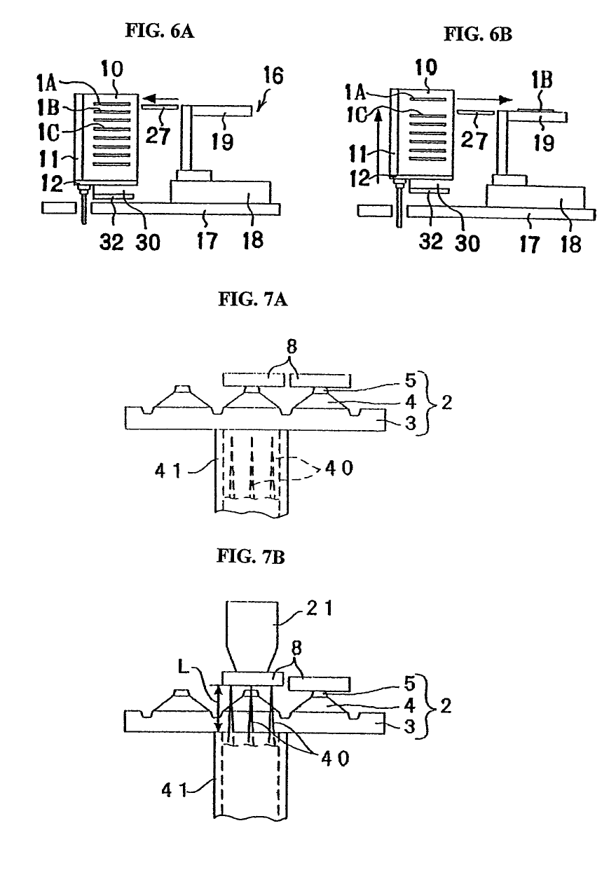

FIGS. 5 and 6 illustrate the operation of the semiconductor pellet processing apparatus of the second embodiment of the present invention.

In the embodiment described above, the heater 32 is provided on the base plate 17. In the embodiment of FIGS. 5A through 5F and 6A and 6B, the heater 32 is provided on the bottom plate 30b (see FIG. 1) of the pocket 30.

The steps shown in FIGS. 5A through 5C are the same as those in FIGS. 3A through 3C. Accordingly, a description of these steps is omitted.

In the state shown in FIG. 5C, the wafer substrate in the wafer ring 1B is heated by the heater 32 provided in the pocket 30. As a result of this heating, as shown in FIG. 9D, the heat-shrinkable adhesive agent 4 shrinks, the bonding area of the radiation-curable adhesive agent 5 also shrinks, and the adhesive strength is weakened. Following this heating for a predetermined time period, the heater 32 is switched off.

In the next step of FIG. 5D, the chuck 26 is advanced and closes, thus chucking the wafer ring 1B. Afterward, the chuck 26 is retracted and pulls the wafer ring 1B from the pocket 30, thus placing the wafer ring 1B on the wafer ring guides 27. In other words, in this embodiment, the steps in which the elevating element 12 is lowered and raised as shown in FIGS. 3D and 3E are unnecessary.

Next, the steps of FIGS. 5E and 5F and FIGS. 6A and 6B are performed. These steps are respectively the same as the steps shown in FIG. 3F and FIGS. 4A, 4B, and 4C. Accordingly, a description of these processes is omitted.

An effect that is the same as that of the embodiment previously described is obtained.

Next, the first pickup operation of the present invention will be described with reference to FIG. 1.

A wafer ring 1 (1A, 1B, 1C . . . ) positioned and held in the wafer ring holding member 19 is irradiated beforehand with ultraviolet light and is heated by the heater 32 in the above-described process shown in FIG. 3D. Accordingly, as shown in FIG. 9D, the heat-shrinkable adhesive agent 4 and radiation-curable adhesive agent 5 shrink, and the adhesive strength of the radiation-curable adhesive agent 5 is greatly weakened.

With the wafer substrate in this condition, the XY table 18 is driven so that the semiconductor pellet 8 that is to be picked up from the wafer ring 1 is positioned above the heater 33.

Next, the heat-shrinkable adhesive agent 4 in the area that corresponds to the semiconductor pellet 8 to be picked up is heated by the heater 33. As a result, the bonding area of the radiation-curable adhesive agent 5 that corresponds to the semiconductor pellet 8 is further reduced, and the adhesive strength is further weakened.

Afterward, the suction-chucking nozzle 21 is lowered, and the semiconductor pellet 8 positioned in the pickup position 20 is suction-chucked by the suction-chucking nozzle 21. Then, the suction-chucking nozzle 21 is raised so that the semiconductor pellet 8 is peeled off of the radiation-curable adhesive agent 5 and picked up. Furthermore, in the apparatus shown in FIG. 1, the wafer substrate 2 can be stretched in the pellet pickup section 16 when the pellets are picked up. However, the semiconductor pellets 8 can be picked up without stretching the wafer substrate 2.

After the suction chucking nozzle 21 suction-chucks and holds the semiconductor pellet 8, an operation similar to that of a conventional apparatus is performed.

In other words, the suction-chucking nozzle 21 is moved in the X and Y directions and the vertical direction, and the semiconductor pellet 8 is placed in a semiconductor pellet positioning part or bonding position (not shown). Then, the suction-chucking nozzle 21 again is moved to the pickup position 20.

When the semiconductor pellet 8 positioned in the pickup position 20 has thus been picked up, the XY table 18 is driven so that a semiconductor pellet 8 that is to be picked up next is positioned in the pickup position 20. Then, semiconductor pellets 8 are successively picked up by the above-described operation.

As seen from the above, the heater 33 performs a spot heating on the heat-shrinkable adhesive agent 4 of a semiconductor pellet 8. Accordingly, there are no particular restrictions on the on-off timing of the heater 33.

The area that is subjected to a spot heat treatment is not limited to the size of a single semiconductor pellet 8. The spot heat treatment can be done for, for instance, 1×n pellets or m×n pellets (n refers to the number of pellets in the longitudinal direction of a wafer substrate and m refers to that in the lateral direction).

FIG. 7 illustrates another pickup operation of the semiconductor pellets 8 in the present invention. In the above-described operation of FIG. 1, the semiconductor pellets 8 are picked up by the suction-chucking nozzle 21 alone. In the embodiment of FIG. 7, the semiconductor pellets 8 are picked up by means of a push-up needle 40 and suction-chucking nozzle 21.

More specifically, as described above, heat is applied to the pellets by the heater 32 (the heater 33 is not used) so that the heat-shrinkable adhesive agent 4 and radiation-curable adhesive agent 5 shrink, and the adhesive strength of the radiation-curable adhesive agent 5 is greatly weakened. As a result, the adhesive strength is weakened to an extent that causes no problems even if the semiconductor pellets 8 are pushed up by a push-up needle 40. Accordingly, it is possible to push up a semiconductor pellet 8 by the push-up needle 40 as shown in FIG. 7B from the state shown in FIG. 7A and to suction-chuck the pellet with the suction chucking nozzle 21.

In FIGS. 7A and 7B, the reference numeral 41 indicates a push-up needle holder. The tests by the inventor indicate that 0.1 to 0.2 mm is ideal as an amount of push-up distance L.

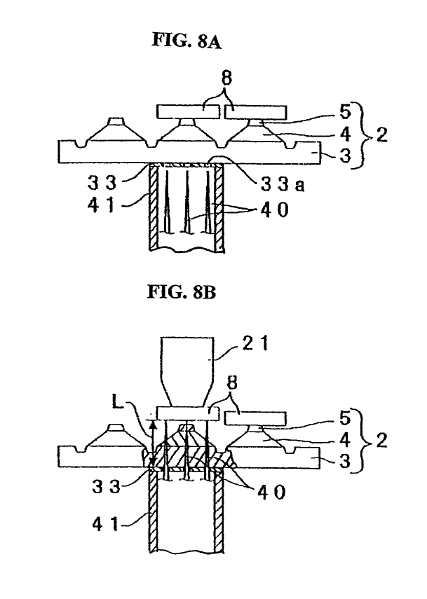

FIG. 8 shows a still another pickup operation of the semiconductor pellets 8 of the present invention.

In the above-described second operation, the heater 33 is not used; and the semiconductor pellets 8, heated by the heater 32, are pushed up by the push-up needle 40. In the operation shown in FIG. 8, the pellet pick up is performed in a manner that combines the operations of FIGS. 1 and 7.

More specifically, in the embodiment of FIG. 8, the heater 33 is used that is formed with holes 33a so that the push-up needles 40 pass through the holes 33a. Alternatively, it is possible to use a heater 33 that has no holes 33a. In this case, the heater 33 is retractable from the area above the push-up needles 40 when the push-up needles 40 are raised and lowered.

Since the heater 33 and push-up needle 40 are used in combination, a pellet pickup is accomplished more reliably.

As seen from the above, the present invention is for a semiconductor pellet processing method and apparatus in which semiconductor pellets bonded to a wafer substrate that is fastened to a wafer ring are supplied to a pellet pickup section and picked up one at a time by a suction chucking nozzle; and in the present invention, the wafer substrate to be processed is comprised at least of a base plate, a heat-shrinkable adhesive agent and a radiation-curable adhesive agent, and the adhesive strength of the radiation-curable adhesive agent is weakened by irradiating the wafer substrate with ultraviolet light, etc. prior to the supply of the wafer ring to the pellet pickup section, then a heat treatment is performed by a heater so as to cause heat shrinkage of the heat-shrinkable adhesive agent and to reduce the bonded area between the radiation-curable adhesive agent and the semiconductor pellets. Afterward, the wafer ring is supplied to the pellet pickup section, and the semiconductor pellets are picked up by the suction-chucking nozzle.

Accordingly, thin semiconductor pellets are picked up without being damaged. Also, a smooth pickup of pellets is performed during the semiconductor pellet pickup process. Thus, the productivity can be improved.

1. A semiconductor pellet processing method in which semiconductor pellets bonded to a wafer substrate that is fastened to a wafer ring are supplied to a pellet pickup section and picked up one at a time by a suction chucking nozzle; wherein
said wafer substrate is comprised of at least a base plate, a heat-shrinkable adhesive agent and a radiation-curable adhesive agent; and wherein said method comprises the steps of:
weakening an adhesive strength of said radiation-curable adhesive agent,
performing a heat treatment on a semiconductor pellet with a heater so as to cause heat shrinkage of said heat-shrinkable adhesive agent and reduce a bonding area between said radiation-curable adhesive agent and said semiconductor pellets,
supplying said wafer ring to said pellet pickup section, and
picking up said semiconductor pellets by a suction-chucking nozzle.

2. The semiconductor pellet processing method according to claim 1, wherein said weakening of said adhesive strength of said radiation-curable adhesive agent is performed by way of irradiating said wafer substrate with ultraviolet light.

3. A semiconductor pellet processing method in which semiconductor pellets bonded to a wafer substrate that is fastened to a wafer ring are supplied to a pellet pickup section and picked up one at a time by a suction chucking nozzle; wherein
said wafer substrate is comprised of at least a base plate, a heat-shrinkable adhesive agent and a radiation-curable adhesive agent; and wherein said method comprises the steps of:
weakening an adhesive strength of said radiation-curable adhesive agent,
performing a heat treatment on a semiconductor pellet with a heater so as to cause heat shrinkage of said heat-shrinkable adhesive agent and reduce a bonding area between said radiation-curable adhesive agent and said semiconductor pellets,
supplying said wafer ring to said pellet pickup section, and
further weakening said adhesive strength of said radiation-curable adhesive agent by way of performing a spot heat treatment with a heater on portions of said base plate that correspond to semiconductor pellets that are to be picked up; and
picking up said semiconductor pellets by a suction-chucking nozzle. chucking nozzle.

4. The semiconductor pellet processing method according to claim 3, wherein said weakening of said adhesive strength of said radiation-curable adhesive agent is performed by way of irradiating said wafer substrate with ultraviolet light.

5. A semiconductor pellet processing apparatus comprising:
a wafer cassette that accommodates wafer rings at a fixed pitch, each of said wafer rings being fastened with a wafer substrate to which semiconductor pellets are bonded,
an elevator device that raises and lowers said wafer cassette,
a wafer ring transfer means that transfers said wafer rings accommodated in said wafer cassette and supplies said wafer rings to said pellet pickup section one at a time, said wafer ring transfer means further transferring used wafer rings, from which said semiconductor pellets have been picked up, back to said wafer cassette, and
a pair of wafer ring guides that guide both side edge portions of said wafer rings transferred by said wafer ring transfer means, wherein
each of said wafer substrates is comprised of at least a base plate, a heat-shrinkable adhesive agent and a radiation-curable adhesive agent,
a pocket is provided in an elevator element of said elevator device, said pocket temporarily accommodating unused wafer rings inside said wafer cassette, and
a heater for heating said wafer substrates is provided in said pocket or on a portion of said processing apparatus that corresponds to said pocket.

6. The semiconductor pellet processing apparatus according to claim 5, further comprising a spot heat treatment heater disposed beneath a pellet pickup position of said pellet pickup section, said spot heat treatment heater performing a spot heat treatment on said heat-shrinkable adhesive agent and radiation-curable adhesive agent both of which corresponding to a semiconductor pellet that is to be picked up.
